(19) United States
(12) Patent Application Publication
(10) Pub. No.: US 2022/0152933 A1
(43) Pub. Date: May 19, 2022

(54) OBJECT GEOMETRY FOR THREE DIMENSIONAL PRINTERS

(71) Applicant: Hewlett-Packard Development Company, L.P., Spring, TX (US)

(72) Inventors: Sergio Gonzalez Martin, Sant Cugat del Valles (ES); Marc Borras Camarasa, Sant Cugat del Valles (ES); Jordi Roca Vila, Sant Cugat del Valles (ES)

(73) Assignee: Hewlett-Packard Development Company, L.P., Spring, TX (US)

(21) Appl. No.: 17/417,731

(22) PCT Filed: Jul. 29, 2019
(86) PCT No.: PCT/US2019/043956

§ 371 Date: Jun. 23, 2021

(51) Int. Cl. B29C 64/386; B33Y 30/00; B33Y 50/00; B33Y 40/20; B29C 64/35; G05B 19/4093

(52) U.S. Cl. CPC B29C 64/386; B33Y 30/00; B33Y 50/00; G05B 2219/32154; B29C 64/35; G05B 19/40931; B33Y 40/20

(57) ABSTRACT

Object geometry for three-dimensional printers is described in which a first object to be three-dimensionally printed is identified. Geometry data relating to a geometry of all or part of the first object can be obtained. The geometry data can be compared with a predetermined threshold. A determination can be made as to whether the first object may or may not be adversely affected by a post-processing apparatus that will be used to process the object during a post-processing operation based on the comparison.

### BACKGROUND

Following a build operation to generate one or more printed objects in a three-dimensional (3D) printer, the printed objects may be subjected to post-processing steps. In powder-based 3D printing systems, for example, a post-processing step may include removal of any non-solidified powder that does not form part of a 3D printed object.

### BRIEF DESCRIPTION OF THE DRAWINGS

FIG. 1 is a schematic diagram showing components of a system according to an example;

FIG. 2 is a flow diagram showing a method of generating modified object model data according to an example;

FIG. 3 is a flow diagram showing a method of obtaining geometry data relating to a first object in an example;

FIG. 4 is a diagram of a virtual bounding box and an object in an example;

FIG. 5 is a schematic diagram showing a controller and changes that may be made to an object representation and part of a post-processing apparatus, according to an example;

FIG. 6 is a schematic diagram showing a controller and changes that may be made to an object representation, according to another example;

FIG. 7 is a flow diagram showing a method of generating information indicative of whether the object will be adversely affected in a post-processing apparatus during post-processing, in an example; and

FIG. 8 is an example of a computer readable medium comprising instructions to generate data indicative of whether the object will be adversely affected in a post-processing apparatus during post-processing according to an example.

### DETAILED DESCRIPTION

In an example of the disclosure, the process of producing a 3D-printed object to a particular specification may include: (i) part and build preparation; (ii) 3D printing; and (iii) post-processing. During the part and build preparation, a digital model of each object to be printed, comprising object model data representing the object, may be generated or received by a pre-printing application. The object model data can define one or multiple 3D geometry models and/or 3D transform matrices including an object model which can position an object to be printed in a 3D printer's printable area. The object model data is in a format that can be read and interpreted by a 3D printer which can carry out a 3D printing build operation.

The object model data may be received by the 3D printer. The 3D printer may comprise a controller to generate printer control data comprising build data based at least in part on the received object model data relating to the object. The printer control data may further comprise instructions to cause the 3D printer to print the build data.

The controller may be a programmable logic device (PLD) or other computing device that can carry out instructions. The controller may include multiple processing elements that are integrated in a single device or distributed across devices.

In powder-based 3D printing, after a 3D build is completed, a build chamber may include a plurality of 3D objects, formed from build material solidified by the 3D printer, along with non-solidified build powder from the build operation. In order to remove the non-solidified powder, a post-processing operation may be performed on the build chamber by a post-processing apparatus. In one example, the post-processing apparatus may remove only the non-solidified powder. In some instances, there may be adverse effects on the 3D objects during post-processing. One adverse effect may, in one example, be caused by openings in the post-processing apparatus, where a 3D object may be unintentionally extracted from the build chamber along with non-solidified powder or could be damaged if a small part of a larger object is caught in an opening. For example, an opening may be a hole or other orifice in the post-processing apparatus through which the non-solidified powder that remains in the build chamber can be removed. In another example, a post-processing apparatus may process a 3D object after printing and the post-processing process may unintentionally damage some kinds of objects or portions on objects, for example, such as objects or portions of objects below a certain size, and objects that have fragile features.

In an example, the post-processing operation is a vacuum operation including a post-processing apparatus that is a vacuum cleaner having a mesh with holes in it through which non-solidified powder from the build chamber may be extracted. In other examples, the post-processing apparatus is a vibrating platform having a mesh on which the build is positioned and through which non-solidified powder may be extracted. Other post-processing operations may include, for example, powder automatic reclaim in which powder is to be automatically extracted from a build chamber, and fast cooling which creates conditions that may adversely affect small objects. Other examples of post-processing operations may include bead blasting, or chemical polishing.

Examples disclosed relate to systems and methods for obtaining geometry data relating to a geometry of all or part of an object or plurality of objects to be 3D printed in a pre-printing operation. Object model data defining an object to be printed by a 3D printer may be obtained. Data relating to the geometry of the object to be printed can be automatically obtained in a pre-printing operation. A comparison of the geometry data with a predetermined threshold can be made and it can be estimated whether it is likely that the object will or will not be adversely affected in a post-processing operation due to its geometry. The geometry may include the size of the object or the size of a portion of the object. In examples, the adverse effect may include passing through an opening of the post-processing apparatus or being damaged by a post-processing apparatus during a post-processing operation due to the geometry information of the object and data relating to the post-processing apparatus. If it is likely that the one of the plurality of objects will pass through the opening or be damaged, the printer control data can be modified to cause an alert so that a user can decide whether or not to proceed with a print job and/or the printer control data can be modified to reduce the likelihood that the object will pass through the opening or be damaged. In an example, the reduction in the likelihood that the object will pass through the opening or be damaged can be achieved by adding a modification to the object. The modified printer control data may be automatically generated in an efficient and reliable manner.

The received object model data may define at least an object to be printed by the 3D printer. In some examples, the object model data may include a plurality of objects to be printed. The objects are to be printed in a build chamber of a 3D printer. To assist in the preparation of the build, the object model data may be modified to include a build envelope within which objects to be printed are to be arranged. The build envelope may, in one example, closely resemble the size and configuration of the printable area in the build chamber. The objects and the build envelope may be represented on a graphical user interface such as a display screen. The objects may be movable within the build envelope to allow re-configuration of the objects such that objects may be rearranged to fit inside the build envelope. Once re-configured, the object model data can be packed and sent to the printer. The printer generates printer control data that may be based on the object model data. For generating the object model data, there can be different criteria to optimise different aspects for efficient and reliable printing. This may include packing density of the objects, distance between objects or the like.

According to examples herein, a controller associated with a 3D printer may determine or estimate whether any of the objects that are to be generated on the basis of the object model data are likely to be adversely affected during a post-processing operation, for example, passing through an opening in a post-processing apparatus or being damaged in some other manner.

In an example where the adverse effect is passing through an opening in a post-processing apparatus, the opening may be a hole in the post-processing apparatus such as a vacuum cleaner that has a plurality of holes which can receive particulate therethrough such as build powder using a suction mechanism. The holes may be on a mesh that is provided in a hose of a vacuum cleaner. Each of the holes in the mesh may be of a size that is large enough to allow non-solidified powder from, for example, a build chamber to fit through the hole and to be extracted from the build chamber. Data relating to the size of the holes in the mesh of the vacuum cleaner can be stored. The data may include the cross sectional size of the hole such as the diameter and area of the hole cross section. In one example, the size data may be manually entered through manual data entry. If all the holes are not of the same size, the largest hole size data or other data that can represent the size of the largest hole in the post-processing apparatus may be obtained. In particular, the cross-sectional threshold size x_{V} of the holes can be predetermined prior to printing and stored in an internal configuration file. The cross-sectional threshold size x_{V} may be a form of data that represents configuration parameters of the post-processing apparatus. The cross-sectional threshold size x_{V} may be represented, in one example, as a length value of a diameter in mm and/or an area value of a surface in mm².

A printing controller may receive the information relating to the objects to be printed and obtain data relating to the post-processing apparatus which in an example is a size of an opening in a vacuum cleaner apparatus. A determination can then be automatically made relating to object geometry data of the objects to be printed. A detection that an object will be adversely affected during a post-processing operation based on the geometry data may be made. In one example, the detection may be if an object will pass through the opening in the post-processing apparatus. The detection may be affirmative if the size of the object in the pre-printing application is smaller than the opening in the post-processing apparatus such as a vacuum cleaner to be used during post-processing in which case the object may be classified as a small object. In one example, this may be achieved by determining whether the model size and/or shape of the object will be smaller than the cross sectional size x_{V} of the holes.

Once a detection that an object will be adversely affected during a post-processing operation based on the geometry data is carried out for all the objects to be printed, a list of objects including a classification of the size of the objects may be generated including a first group of objects that are objects that may be adversely affected by a post-processing apparatus and a second group of objects that include the rest of the objects i.e. those that may not be adversely affected by a post-processing apparatus. The list may be displayed on a display unit, for example, of a printer and the objects in each group may be highlighted on the display unit and/or selectable by a user.

If it is detected that one or a plurality of the objects is a an object that may be adversely affected by a post-processing apparatus which in the example that the post-processing apparatus is one with holes to receive non-solidified powder is that the object is smaller than the holes of the post-processing apparatus, the print control data may be modified to prevent the object passing through the hole.

In an example, the print control data may be modified by automatically adding a structure to the object model data of an identified object to create a modified object comprising the structure and at least one or all of the objects in the first group, the modified object having a geometry, such as a size, that will not be adversely affected by a post-processing apparatus during a post-processing operation. The structure may be a digital representation of a predetermined structure that is automatically generated and suggested by the printer and/or be digitally created by a user in the printer.

In an example, the structure may be a protective housing or cage or frame that surrounds some or all the objects that are small enough to pass through the hole in the post-processing apparatus or small enough to be damaged by some other process, such as chemical polishing. The structure may partially surround the objects but to a sufficient extent to keep the objects within the structure and to prevent the object from being adversely affected by a post-processing apparatus during a post-processing operation. The modified object that is created may include at least one or all of the objects from the first group and the structure. The modified object may be of a different geometry to each object in the first group such that the modified object will not be adversely affected by a post-processing apparatus during a post-processing operation. In an example where the post-processing apparatus includes holes to receive and extract powder from a build chamber, the modified object will be of a larger size, or will have a geometry, such that it will not pass through the holes in the post-processing apparatus.

In another example, the structure comprises a removable part to connect to an object in the first group. The removable part may be one or a plurality of connectors such as sprues to releasably connect at least two of the objects in the first group together. Alternatively, at least one object in the first group may be connected with a larger object such as one in the second group, connected to another automatically generated object, or more than two objects may be connected together.

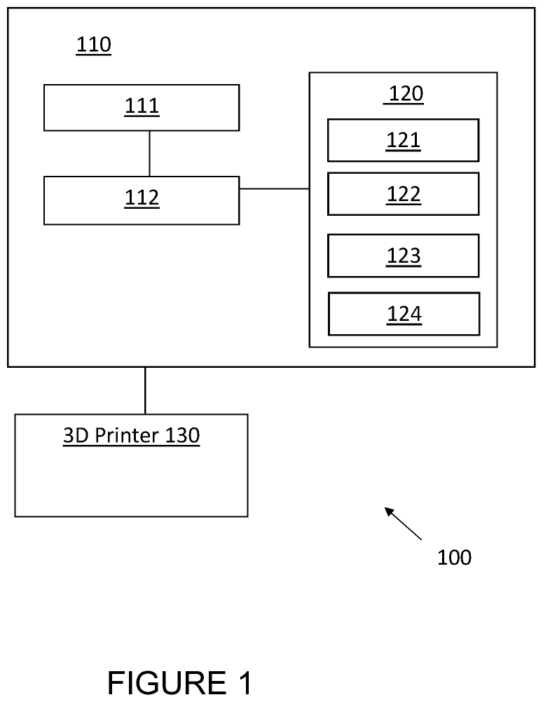

With reference to FIG. 1, there is shown an example system according to the present disclosure. In this example, the system 100 comprises a controller 110. The controller 110 may comprise a plurality of components, some of which are described below. The controller may be a programmable logic device (PLD) or other computing device that can carry out instructions. The controller may include multiple processing elements that are integrated in a single device as described in the example below or distributed across devices.

The controller 110 of the system 100 may comprise a data input/output interface unit 111 to receive input data from external components, for example, user input devices (not shown) to allow a user to interact with the system 100. The unit 111 may also output data from the controller 110 to other external components, for example, a display unit (not shown).

The controller 110 may further comprise a processor 112 to manage all the components within the controller 110, and process all data flow between the components within the controller 110. The processor may be any of a central processing unit, a semiconductor-based microprocessor, an application specific integrated circuit (ASIC), and/or other device suitable for retrieval and execution of instructions.

The controller 110 may further comprise a storage or memory unit 120 to store any data or instructions which may need to be accessed by, for example, the processor 112. The memory unit 120 may be any form of storage device capable of storing executable instructions, such as a non-transient computer readable medium, for example Random Access Memory (RAM), Electrically-Erasable Programmable Read-Only Memory (EEPROM), a storage drive, an optical disc, or the like.

In one example, the memory unit 120 includes instructions such as instructions 121 to identify a first object to be three-dimensionally printed, instructions 122 to obtain geometry data relating to a geometry of all or part of the first object, instructions 123 to compare the geometry data with a predetermined threshold, and instructions 124 to determine whether the first object will or will not be adversely affected by a post-processing apparatus that will be used to process the object during a post-processing operation based on the comparison. If the determination is negative, the controller may analyse another object and carry out the determination for the other object. Printer control data may be modified on the basis of the determination and the modified printer model data may be stored. A 3D printer 130 may be connected to the controller 110 in that it may be incorporated into a 3D printer or associated with the 3D printer. The controller 110 may control aspects of the 3D printer 130. In one example, the printer control data is provided to the printer 130 to cause the printer 130 to carry out a 3D printing operation.

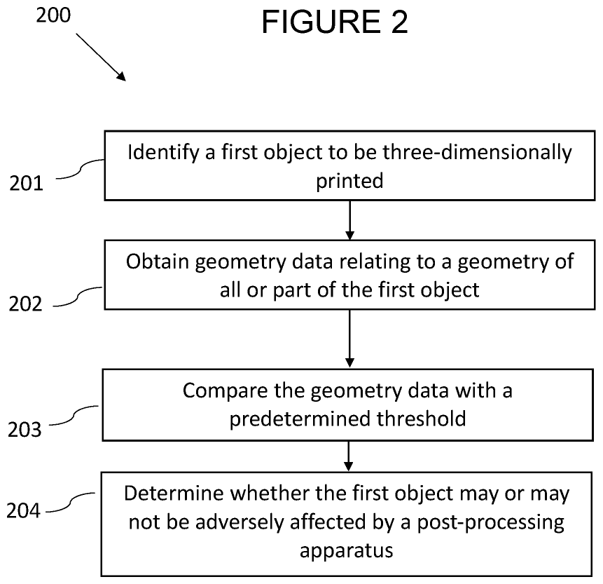

FIG. 2 shows an example of a method 200 for determining whether a first object will or will not be adversely affected by a post-processing apparatus. In examples, the post-processing operation may be a de-caking operation, a bead-blasting operation and/or a chemical polishing operation. The method comprises identifying 201 a first object to be printed by a three-dimensional printer. In one example, the identifying may be achieved by analysing object model data received by the controller 110 shown in FIG. 1 and generating build data on the basis of the object model data. The received data may be stored in any suitable manner, for instance, in an electronic file containing information pertaining to the objects including the first object to be printed. The electronic file may be obtained from an external device or a local data store. The method 200 further comprises obtaining 202 geometry data relating to a geometry of all or part of the first object. In one example, this may be obtained by generating a plurality of slices of the first object or part of the first object in an orthogonal direction using planes at different distances along an axis or a plurality of axes of the first object or part of the first object to generate geometry data relating to the geometry of all or part the first object. The generation of a plurality of slices may be using planes with different orientations at each different distance. At 203, the geometry data may be compared with a predetermined threshold. In an example where the geometry data is obtained by generating a plurality of slices of the first object or part of the first object, the comparing the geometry data with a predetermined threshold may include comparing whether a slice of the first object or the part of the first object is larger than the predetermined threshold. At 204, it is determined whether the first object may or may not be adversely affected by a post-processing apparatus that will be used to process the object during a post-processing operation based on the comparison at 203. In one example, the adverse effect may be the object passing through an opening in a post-processing apparatus. In another example, the adverse effect may be likely damage due to the object being small and/or having fragile features. In an example, an indication may be provided that the first object will not be adversely affected by a post-processing apparatus that will be used to process the first object during a post-processing operation of the post-processing apparatus if the geometry data indicates that the size of all or part of the first object is larger than the predetermined threshold. Alternatively, an indication may be provided that the first object will be adversely affected by a post-processing apparatus that will be used to process the first object during a post-processing operation of the post-processing apparatus if the geometry data indicates that the size of all or part of the first object is not larger than the predetermined threshold. In an example where the geometry data is obtained by generating a plurality of slices of the first object or part of the first object, it may be determined that a slice of the plurality of slices along an axis of the first object or part of the first object is larger than the predetermined threshold and this may provide information in relation to the first object not likely being adversely affected by a post-processing apparatus that will be used to process the first object during a post-processing operation. This analysis may be carried out for a plurality of axes of the first object or part of the first object to provide information in relation to whether the first object is likely to be adversely affected by a post-processing apparatus.

In addition, printer control data comprising build data based at least in part on object model data relating to the first object may be generated by the controller 110. If the determination at 204 is that the first object will likely be adversely affected by a post-processing apparatus that will be used to process the first object during a post-processing operation of the post-processing apparatus, the controller 110 may cause generation of an alert on the basis of the determination. The alert may be a warning that one or more objects are likely to be adversely affected by a post-processing apparatus during a post-processing operation. The alert may identify the particular object or objects that will likely be adversely affected. In an example, the alert could be a visual prompt on a display device, for example, of the 3D printer 130 and/or audible prompt from the 3D printer 130.

In another example, if the determination at 204 is that the first object will likely be adversely affected by a post-processing apparatus that will be used to process the first object during a post-processing operation of the post-processing apparatus, the controller 110 may cause the controller to generate modification data proposing a modification of the first object to prevent it from being adversely affected by the post-processing apparatus that will be used to process the object during a post-processing operation. The modification may be adding a structure such as a protective cage around the first object to surround the first object or a connector to connect to the first object. The combination of the structure and the first object may be of a different geometry to the first object so as not to be adversely affected by the post-processing apparatus during the post-processing.

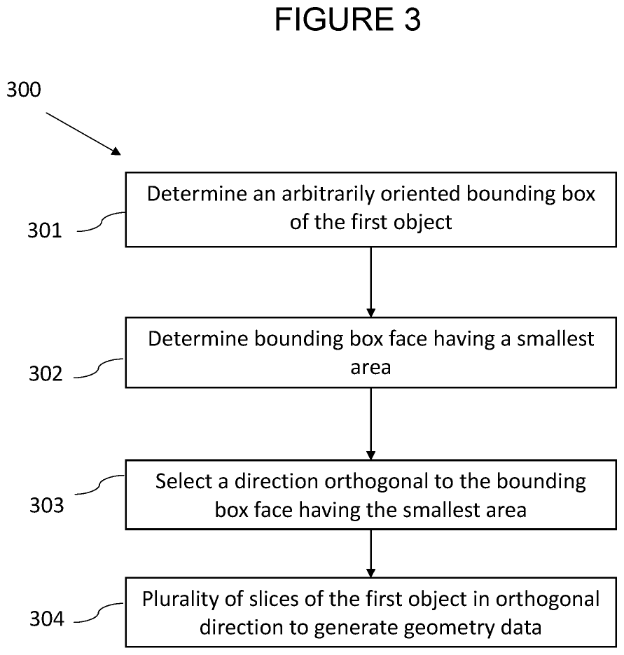

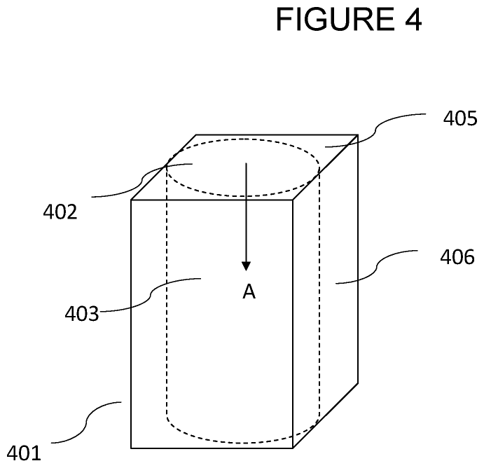

Referring to FIGS. 3 and 4 in which FIG. 3 shows a method 300 including a more detailed example in relation to block 202 of FIG. 3 that may be performed by the controller 110 of FIG. 1 and shows how geometry data relating to the first object can be obtained. The same method can be used for each object. FIG. 4 shows a diagram of an example virtual bounding box and an object. At 301, an arbitrarily oriented bounding box 401 of the first object 402 is determined. In one example, the bounding box may be a cuboid and may be a minimum arbitrarily oriented bounding box relative to the first object. In another example, the bounding box may be a slightly larger bounding box relative to the first object and/or may be another shape or bounding volume such as a sphere. In the example where the bounding box 401 is a cuboid, the box 401 may have a six faces. Only three faces 403-406 are shown in the diagram but the virtual bounding box will have six faces. An area of each face of the bounding box may be calculated. At 302, a determination can be made as to which of the faces has the smallest surface area compared to other faces. In one example, the bounding box face of the bounding box having the smallest area relative to the area of each of the faces may be determined. In the example of FIG. 4, the face 405 has the smallest area compared to the other faces. In an example, the area of three pairs of faces may be determined instead of the area of all six faces of the bounding box as the size of the two faces of each pair may be the same for particular types of bounding boxes such as rectangular cuboids. At 303, a direction of the smallest size bounding box face may be obtained by selecting a direction orthogonal A to the bounding box face having the smallest area. At 304, a plurality of slices of the first object in the orthogonal direction is generated using planes at different heights or distances from the smallest area bounding box face 405 in order to generate geometry data xᵢ relating to the geometry of all or part of the first object, which in one example may be indicative of the size of the first object 402 or a portion of the first object. The geometry data xᵢ may be represented, in one example, as a length value of a diameter in mm and/or an area value of a surface in mm². The diameter and area value of each plane may be determined. In carrying out the comparing at block 203, the controller 110 may judge that for the object to be adversely affected by a post-processing apparatus during post-processing, which in one example, may be a judgement that the object may pass through the opening, the following condition is to be met:

xᵢ≤x_{V}

where xᵢ is value representing as estimate of the cross sectional geometry of part of the object and x_{V} is the predetermined threshold that in one example may be an approximation of the cross sectional geometry of an opening in a post-processing apparatus. The geometry data xᵢ as obtained in 304 of FIG. 3 may be compared with the predetermined threshold x_{V} at 203 of FIG. 2. In an example, the comparing may include comparing whether a slice of the first object or the part of the first object as obtained in method 300 is larger than the predetermined threshold, and wherein if the slice is larger than the predetermined threshold, the indication at 204 of FIG. 2 will be determining that the first object will not be adversely affected by a post-processing apparatus that will be used to process the first object during a post-processing operation. If a slice of the first object or the part of the first object as obtained in method 300 is not larger than the predetermined threshold, a different height of the object is sliced in the orthogonal direction and compared at 203 of FIG. 2. This process can be repeated across the different heights from the smallest area bounding box face of the first object or part of the first object that is being analysed. If all the analysed slices are not larger than the predetermined threshold x_{V}, this may provide an indication that the first object or the part of the first object being analysed may be adversely affected by a post-processing apparatus that will be used to process the first object.

In another example, the method 300 may be performed without 302 or 303 in which case the analysis in 304 is performed for each face of the bounding box rather than only the smallest area face and each of the slices for each face are compared to the predetermined threshold x_{V}.

Other ways of obtaining geometry data may be used in other examples. In alternative examples, the controller 110 may receive input geometry data from a user, or the controller 110 may receive the geometry data from a predetermined location in its internal memory or through accessing the data from another external location.

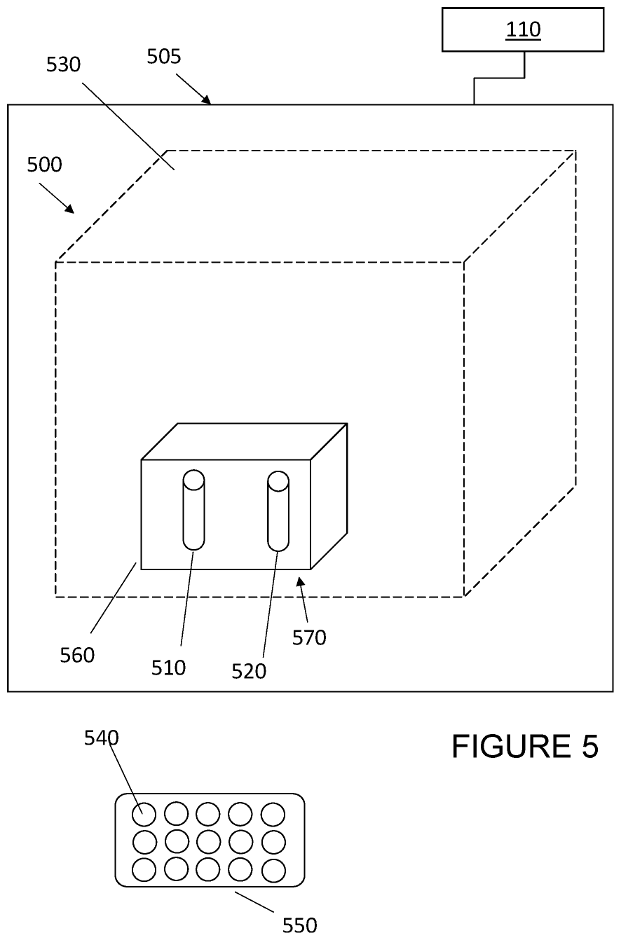

FIG. 5 shows a simplified schematic diagram of the controller 110 and a 3D virtual representation 500 of the objects to be printed according to the printer control data. Also shown is a top perspective view of part of a post-processing apparatus such as a vacuum cleaner with openings to receive non-solidified powder during a post-processing operation. In the example, there are a plurality of objects defined by object model data, and in the simplified example shown in FIG. 5, a first object 510 and a second object 520 are to be printed and are defined in object model data in a pre-printing application by the controller 110. The simplified diagram shows two objects but more objects may be provided in other examples. The object model data received may further comprise data relating to a virtual build envelope 530 which is a virtual representation of a build chamber in a build unit including the objects 510,520 that are to be printed. The controller 110 may cause the display to spatially arrange the first object 510 and second object 520. The controller 110 may determine whether both the first object 510 and the second object 520 will pass through opening 540 of a post-processing apparatus 550 during post-processing based on a geometry of the first object 510 and a geometry of the second object 520 to be generated. The figure shows a post-processing apparatus comprising fifteen openings but other numbers of openings could be provided and the number, size and/or configuration will depend on the particular post-processing apparatus.

The controller 110 may change the object representation and modify the printer control data by adding a structure 560 that may surround the first object 510 and second object 520. This may create modified object 570 that is of size that will not be adversely affected by a post-processing apparatus during a post-processing operation. In an example, the geometry of the modified object 570 may be such that it will not pass through the opening 540 of the post-processing apparatus 550 shown in FIG. 5. In another example, the structure 560 may prevent damage of and protect the objects 510, 520 contained within the structure 560 during post-processing. In some examples, the structure 560 may be created without having moved the objects relative to each other.

In some examples, the structure 560 may be a digital representation of a predetermined structure that is automatically generated and suggested by a printing application on the printer and/or be digitally created by a user in the printing application.

In an example, the structure may be a protective housing or cage or frame that encapsulates some or all the objects that are small enough to be adversely affected by a post-processing apparatus during a post-processing operation.

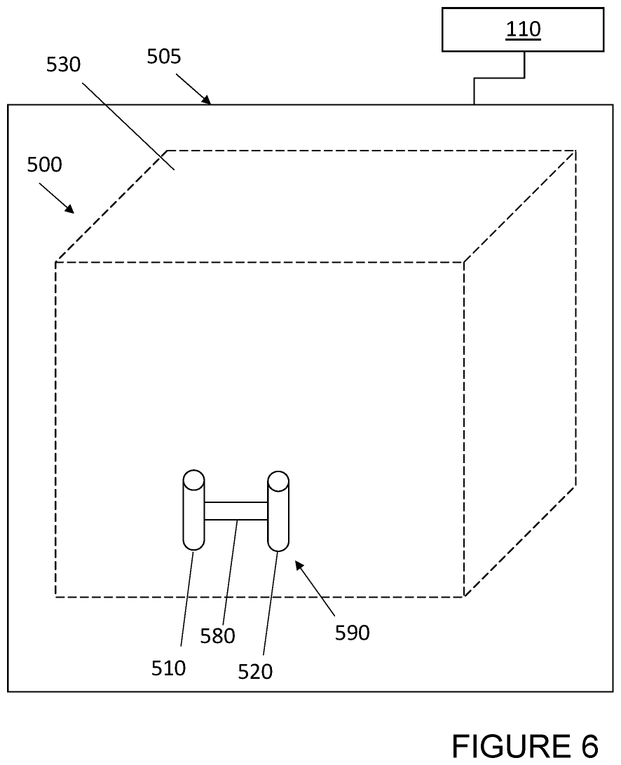

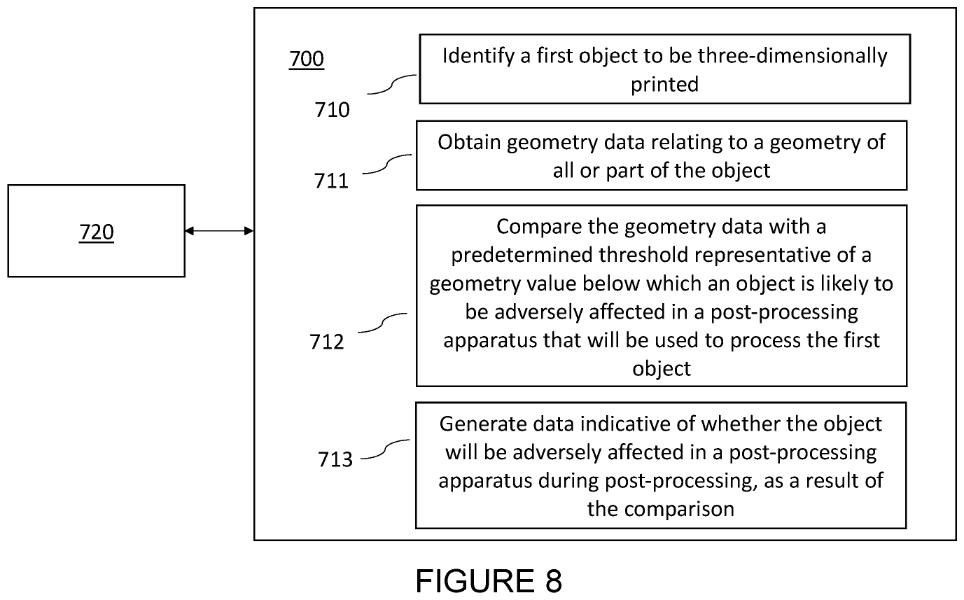

With reference to FIG. 6, in another example, as with FIG. 5, the controller 110 may modify the data relating to the virtual build envelope to add a structure 580. In this example, the structure comprises one connector 580 such as a sprue to removably connect at least two of the objects such as the first object 510 and second object 520 and in an orientation to create a modified object 590 that is of geometry that will not be adversely affected by a post-processing apparatus during a post-processing operation. In an example, the geometry of the modified object may be such that it will not pass through the opening 540 of the post-processing apparatus 550 shown in FIG. 5. In the example shown in FIG. 8, the connector is perpendicular to a surface of the object. In another example, the connector may be angled at an acute or obtuse angle relative to the surface of the object. In yet another example, the connector(s) may connect at least one object to a larger object or more than two objects may be connected together to create a modified object that is of a geometry that will not be adversely affected by a post-processing apparatus during a post-processing operation. The connector 580 may be removed from printed objects after the post-processing operation has been performed. In other examples, a plurality of connectors may be removably connected to one or more of the objects. In some examples, the connector may be created without having moved the objects relative to each other.

After the modified object 590 has been generated, the modified printer control data can be sent to the 3D printer such as the 3D printer 130 of FIG. 1 for printing the objects based on the build data. The likelihood that objects are adversely affected during a post-processing operation may therefore be reduced or removed as a result of the pre-printing process that is carried out according to examples described herein.

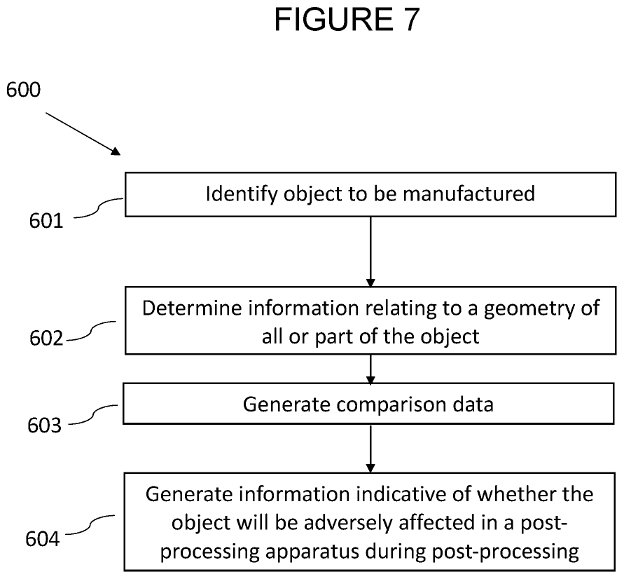

In another example method 600 as shown in FIG. 7, at 601, an object to be manufactured by a three-dimensional printer is identified. At 602, information relating to a geometry of all or part of the object is determined. At 603, comparison data representative of the geometry information relative to a predetermined threshold is generated. At 604, information indicative of whether the object will be adversely affected in a post-processing apparatus during post-processing is generated, based in part on the comparison data.

FIG. 8 shows a memory 700, which is an example of a computer readable medium storing instructions 710, 711, 712, 713 that, when executed by a processor 720 communicably coupled to a computing device, may cause the processor 720 to generate data indicative of whether the object will be adversely affected in a post-processing apparatus in accordance with any of the examples or flow diagrams described above. The computer readable medium may be any form of storage device capable of storing executable instructions, such as a non-transient computer readable medium, for example Random Access Memory (RAM), Electrically-Erasable Programmable Read-Only Memory (EEPROM), a storage drive, an optical disc, or the like.

In addition to the examples described in detail above, the skilled person will recognize that various features described herein can be modified and/or combined with additional features, and the resulting additional examples can be implemented without departing from the scope of the system of the present disclosure, as this specification merely sets forth some of the many possible example configurations and implementations for the claimed solution.

1. A system comprising:
a controller to:
identify a first object to be three-dimensionally printed;
obtain geometry data relating to a geometry of all or part of the first object;
compare the geometry data with a predetermined threshold; and
determine whether the first object may or may not be adversely affected by a post-processing apparatus that will be used to process the object during a post-processing operation based on the comparison.

2. The system according to claim 1, wherein obtaining geometry data further comprises:
generating a plurality of slices of the first object or the part of the first object using planes at different distances along an axis or a plurality of axes of the first object or part of the first object to generate geometry data relating to the geometry of all or part the first object.

3. The system according to claim 1, wherein obtaining geometry data further comprises:
determining an arbitrarily oriented bounding box of the first object or a part of the first object, the bounding box having a plurality of faces;
determining which of the plurality of faces has the smallest area;
selecting a direction orthogonal to the determined bounding box face having the smallest area;
generating a plurality of slices of the first object or the part of the first object in the orthogonal direction using planes at different heights from the smallest area bounding box face to generate geometry data relating to the geometry of all or part the first object.

4. The system according to claim 3, wherein the generating comprises generating a plurality of slices using planes with different orientations at each different height.

5. The system according to claim 4, wherein the comparing the geometry data with a predetermined threshold includes comparing whether a slice of the first object or the part of the first object is larger than the predetermined threshold, and wherein if the slice is larger than the predetermined threshold, the determining includes determining that the first object will not be adversely affected by a post-processing apparatus that will be used to process the first object during a post-processing operation.

6. The system according to claim 1, wherein if the determination is that the first object will be adversely affected by a post-processing apparatus that will be used to process the first object during a post-processing operation of the post-processing apparatus, the controller is to cause:
generation of an alert on the basis of the determination and/or
generation of modification data proposing a modification of the first object to prevent it from being adversely affected by the post-processing apparatus that will be used to process the object during a post-processing operation.

7. The system according to claim 6, wherein the modification is at least one of:
adding a connector to the first object; and
adding a protective cage to wholly or partially surround the first object.

8. The system according to claim 6, wherein the controller is to generate printer control data comprising build data based at least in part on object model data relating to the first object and the modification data, wherein the printer control data further comprises instructions to cause a three-dimensional printer to print the build data.

9. The system according to claim 1, further comprising a three-dimensional printer and the controller is to control the three-dimensional printer.

10. The system according to claim 1, wherein the adverse effect is whether all or part of the first object may fit in an opening in a post-processing apparatus.

11. The system according to claim 1, wherein the controller is to identify a plurality of objects and to carry out the obtaining, comparing and determining in relation to each object of the plurality of objects.

12. A method comprising:
identifying an object to be manufactured by a three-dimensional printer;
determining information relating to a geometry of all or part of the object;
generating comparison data representative of the geometry information relative to a predetermined threshold; and
generating information indicative of whether the object will be adversely affected in a post-processing apparatus during post-processing, based in part on the comparison data.

13. The method according to claim 11, wherein the generating information indicative of whether the object will be adversely affected in a post-processing apparatus during post-processing comprises:
generation of an alert on the basis of the determination and/or generation of modification data proposing a modification of the first object to prevent it from being adversely affected by the post-processing apparatus that will be used to process the object during a post-processing operation.

14. The method according to claim 12, wherein the modification is at least one of:
adding a connector to the first object; and
adding a protective cage to wholly or partially surround the first object.

15. A non-transitory computer-readable medium comprising instructions, which when executed on a computing device, cause the computing device to:
identify a first object to be three-dimensionally printed;
obtain geometry data relating to a geometry of all or part of the object;
compare the geometry data with a predetermined threshold representative of a geometry value below which an object is likely to be adversely affected in a post-processing apparatus that will be used to process the first object; and
generate data indicative of whether the object will be adversely affected in a post-processing apparatus during post-processing, as a result of the comparison.
